(19) United States
(12) Patent Application Publication
(10) Pub. No.: US 2007/0150671 A1
(43) Pub. Date: Jun. 28, 2007

(54) Supporting macro memory instructions

(75) Inventor: Aaron S. Kurland, Lexington, MA (US)

Correspondence Address: WOLF GREENFIELD & SACKS, P.C., 600 ATLANTIC AVENUE, BOSTON, MA, 02210-2206, US

(73) Assignee: Boston Circuits, Inc., Burlington, MA (US)

(21) Appl. No.: 11/318,238

(22) Filed: Dec. 23, 2005

(51) Int. Cl. G06F 13/00

(52) U.S. Cl. 711/154

(57) ABSTRACT

The amount of processor resources and processor-memory bandwidth needed to perform certain memory operations over blocks of memory locations is reduced by supporting macro memory instructions. An intelligent memory controller is operatively connected to one or more processors and to at least one memory. The intelligent memory controller receives macro memory instructions sent from one or more of the processors and translates the macro memory instructions into corresponding sequences of atomic memory instructions to be executed by a memory. While the intelligent memory controller manages execution of the corresponding sequence of atomic memory instructions, the processor which issued the macro memory instruction may continue doing useful work not relying on the result or affected locations of the macro memory instruction.

### FIELD OF THE INVENTION

The present invention relates generally to the interface between a processor and a memory. More specifically, the invention relates to systems and methods for decreasing the amount of processor resources and processor-memory bandwidth needed to perform certain memory operations over blocks of memory locations, by supporting macro memory instructions.

### BACKGROUND

Memory devices have become an indispensable component of nearly every information-processing system and device in use today. These memory devices are read from and written to by processors which typically operate by executing a series of atomic operations (e.g., read a byte, write a byte, etc.) defined by low-level instructions resulting from a process of translation (e.g., compilation, interpretation, or just-in-time compilation) from a high-level language such as C, C++, or Java. Many of these high-level languages have built-in primitive functions for performing specialized memory operations such as memory-to-memory transfers and string manipulation, built from atomic operations. These primitive functions are often defined within libraries included with the language's development platform.

The interface between a processor and a memory is typically very basic and provides only enough functionality to read and write amounts of data. This limited interface requires that the aforementioned built-in primitive functions be translated into a series of atomic read and write instructions which are then executed by the processor. The result is the consumption of precious processor resources and memory bus bandwidth proportional to the number of affected memory locations. In many cases, moreover, the processor must forgo doing other useful work while each atomic memory instruction is completed. Memory operations, therefore, may consume considerable system resources.

The degree to which memory operations impact overall time required for executing an algorithm depends on the nature of the algorithm. Among the algorithms that require a lot of memory operations are those that operate on matrices of data, particularly large matrices. For example, modem digital signal processing algorithms used to process speech, video, and sensor data extensively employ matrix operations. Speeding up such algorithms is an ever-present goal, to permit implementation of more complex, and better signal processing. Faster processors and memory designs help, but are not sufficient.

One response to a demand for greater processing capability is the development of so-called “multi-core” processing chips. However, the presence of multiple cores trying to access common memory only accentuates the impact of processor-memory interaction on overall data processing performance. Not only must a single processor core wait for a memory instruction to complete, but multiple cores may be kept waiting.

Needs thus exist for further efficiencies and speed in processor-memory interaction and for memory interaction techniques which consume fewer processor cycles. There further exist needs for more efficient interaction between multiple processor cores and a shared memory.

### SUMMARY

In exercising certain algorithms as discussed above, it has been found that considerable processor time and memory bus bandwidth may be consumed, specifically, in performing highly repetitive operations on blocks of memory. For example, blocks of data may have to be copied or moved. And some kinds of applications such as image processing (graphics) and signal processing, in general, commonly involve such operations on matrices of data. The elements of two image matrices may have to be added, for example, or the rows and columns of a matrix may have to be inverted or transposed. Accordingly, a series of operations are performed on a first “cell” in the matrix and then the same series of operations is performed on a next cell, and on the one after that until the whole matrix has been processed. Having recognized that it would be desirable to offload from the processor(s) the task of executing these repetitive block memory operations, methods and systems are presented for supporting macro memory instructions.

Accordingly, in one aspect of the invention, a controller supporting macro memory instructions is provided. This controller preferably includes input logic which is arranged and configured to receive incoming data from a processor. This incoming data may include macro memory instructions, which substantially represent block memory operations (i.e., memory operations involving at least one block of consecutive or non-consecutive memory locations which will be operated on in like fashion). The controller also preferably includes processing logic which is arranged and configured to execute received macro memory instructions by generating, and then executing, a corresponding sequence of atomic memory instructions. The controller also preferably includes output logic which is arranged and configured to send outgoing data to a memory, the outgoing data including the atomic memory instructions that are generated by the processing logic. The processor can issue a macro memory instruction to the controller (or memory); the controller translates and executes the macro memory instruction while the processor is freed up for other uses; once the macro memory instruction has been executed, the processor is so notified. No modifications to the memory are required.

According to another aspect, an intelligent memory controller supporting macro memory instructions is provided, comprising processing logic and output logic. The processing logic is configured and arranged to receive macro memory instructions from input logic and to generate, for each received macro memory instruction, a corresponding sequence of atomic memory instructions. The output logic is configured and arranged to send outgoing data to a memory, the outgoing data comprising the atomic memory instructions from the processing logic. The output logic may be configured and arranged to send outgoing data to the processor. Such outgoing data may comprise a return value resulting from the execution of a macro memory instruction. The controller may further comprise logic configured and arranged to receive a status request and send a status update, the status update comprising the status of the execution of a macro memory instruction. The controller may further comprise input logic configured and arranged to receive incoming data from the memory.

In some embodiments of some of the foregoing arrangements, the controller may further comprise logic configured and arranged to support the queuing of at least some of the incoming and outgoing data.

In some instances, the controller may further comprise logic configured and arranged to perform arithmetic and/or logical operations using at least some of the incoming data.

In some instances, the controller may further comprise logic configured and arranged to send an interrupt request after a macro memory instruction is executed.

According to a further aspect, an information processing system is shown which supports macro memory instructions. The system comprises a processor; memory; and an intelligent memory controller, the intelligent memory controller being configured and arranged to receive a macro memory instruction issued by the processor and to execute the macro memory instruction by effecting on the memory a corresponding sequence of atomic memory instructions. The macro memory instruction may be selected from among a set of macro memory instructions, the set of macro memory instructions consisting substantially of block memory operations. The processor and intelligent memory controller may be constructed upon a same substrate; alternatively, the intelligent memory controller may be constructed upon a first substrate and the processor may be constructed upon a second substrate different from the first substrate. In either situation, the memory and the intelligent memory controller may be constructed upon a same substrate or different substrates. Optionally, the intelligent memory controller may be configured and arranged to notify the processor of the completion of the execution of a macro memory instruction. Also, the memory may be configured and arranged to notify the processor of the completion of the execution of a macro memory instruction. Notification may be at least partly accomplished by setting an interrupt. The intelligent memory controller also may be configured and arranged to send the processor a return value for the execution of a macro memory instruction. Likewise, the memory may be configured and arranged to send the processor a return value for the execution of a macro memory instruction. Such return values may be sent, at least partly, by setting the contents of a register. The intelligent memory controller may notify the processor of completion of the execution of the macro memory instructions in response to a status request sent by the processor.

In some embodiments, the intelligent memory controller may comprise hard-wired logic. It also may comprise one or more processors.

The system may include a communication network operatively interconnecting at least two of the processors and the intelligent memory controller for communication and wherein the macro memory instructions are delivered through the communication network. Such communication network may be constructed to provide selective communication between the processors and the intelligent memory controller.

The system may further include an intermediary component, and wherein the macro memory instructions are delivered from a processor to the intelligent memory controller via the intermediary component. Macro memory instructions issued by at least two of the plurality of processors may be delivered to the intelligent memory controller via the intermediary component, and the intermediary component may schedule the execution of each of the macro memory instructions delivered through it.

The intermediary component may be arranged and configured to receive a return value sent by the intelligent memory controller.

According to a still further aspect, a method is provided for operating a computer system. The method comprises acts of a processor issuing a macro memory instruction; an intelligent memory controller receiving the issued macro memory instruction; and the intelligent memory controller executing the issued macro memory instruction by effecting on a memory a corresponding sequence of atomic memory instructions. The method may further comprise the act of, after the completion of the foregoing acts, the intelligent memory controller notifying the processor or the memory notifying the processor. In either case, an interrupt request may be used to notify the processor.

The method of claim may further comprise, the act of, upon completing said executing, act, the intelligent memory controller or the memory sending the processor a return value for the execution of the macro memory instruction. The return value may be sent, at least partly, by setting of the contents of a register or through a communication network, the communication network permitting communication between the processor and the intelligent memory controller.

The macro memory instruction may be sent to the intelligent memory controller via an intermediary component. The return value also may be sent to the intermediary component.

The method may further comprise an act of the processor polling the intelligent memory controller and/or the memory.

Subsequent to issuing a macro memory instruction and the execution of that instruction, the processor may continue to execute instructions.

Prior to the controller receiving the macro memory instruction, the issued macro memory instruction may be routed selectively through a communication network to the communication channel.

The above and other features and advantages of the present invention will be appreciated from the following detailed description of example embodiments, which should be read in conjunction with the accompanying drawing figures.

### BRIEF DESCRIPTIONS OF THE DRAWINGS

In labeling elements of the figures, it is noted that elements which have substantial similar functionality from one figure to the next are given the same label in each figure. Elements which are likely to have more functionality or functionality which may differ substantially from an apparently similar element in another figure are given different labels.

FIG. 1 shows an example of an interface between a processor and a memory that supports only atomic memory instructions, as known in prior art.

FIG. 2 shows an example of a basic system, in accordance with some aspects of the present invention, for supporting only macro memory instructions that do not yield return values.

FIG. 3 shows an example of a more complex system, in accordance with some aspects of the present invention, for supporting both macro memory instructions and atomic memory instructions which may yield return values.

FIG. 4 shows an example of a more general system supporting macro memory instructions with multiple processors, intelligent memory controllers, and memories according to aspects of the present invention.

FIG. 5A, 5B and 5C are partial block/functional diagrams of logical modules for implementing an example embodiment of an intelligent memory controller such as the one illustrated in FIG. 3.

### DETAILED DESCRIPTION

As stated above, needs have been recognized for systems and methods for improving the efficiency of interaction between a processor and memory. These needs can be met by reducing the time the processor has to devote to memory operations and by reducing the usage of the communication channel operatively connecting the processor to the memory. The systems and methods disclosed herein address these needs by generally supporting macro memory instructions, which allow a processor to delegate the execution of certain memory operations (typically involving block operations) to an intelligent memory controller on the memory “side” of the communication channel.

Before proceeding, it may be useful to clarify the meanings of some of the terminology used to describe aspects of the present invention.

“Logic,” as used herein, refers to fundamental computing elements arranged and configured to perform useful computational functions. When physically constructed, logic is built of logic elements. The material within or upon which logic elements are constructed is called a “substrate” (e.g., silicon). The logic elements may comprise, for example, gates capable of implementing Boolean operations, and the constituent transistors, quantum dots, DNA, biological or artificial neurons, or any other suitable elements implementing gates, and structures formed of gates, such as registers, etc. The term logic may also be broadly used to describe an arrangement comprising a processor (e.g., general purpose processor), or a portion thereof, when properly arranged and configured to perform logical operations, separate from or together with associate program code.

A “processor,” as used herein, is minimally an arrangement and configuration of logic capable of sending macro memory instructions. The processor may further comprise any combination of the following: logic enabling it to serve as a general purpose processor for executing a series of instructions (i.e., an executable program), logic for multi-tasking (i.e., executing more than series of instructions in parallel), logic for receiving and handling interrupt requests, logic for sending and receiving data, logic for communicating over a communication network, logic for caching data, logic for queuing data, and logic for polling as described herein. A processor may be implemented in various ways, such as a programmable microprocessor or microcontroller, a special purpose programmable processing unit, an arithmetic logic unit (“ALU”), an application-specific integrated circuit (“ASIC”), or as an optical processing unit, to give a few non-limiting examples.

A “communication link,” as used herein, is a physical conduit for transmitting data, together with any required interface elements. Each communication link may utilize one or a combination of media (e.g., conductive wire, wireless frequency band, optical fiber, etc.) to transmit data and may do so serially or in parallel and may be connected together using components such as transceivers, hubs, switches, and routers to form a more general communication network. The media include, but are not limited to: electrical, optical, wireless, magnetic, chemical, and quantum entanglement. Communication links may carry data for a portion of a channel, an entire channel, or multiple channels.

A “channel,” as used herein, refers to a logical conduit across which data may be transmitted.

A “memory,” as used herein, refers to a device for storing data permanently or temporarily, and includes logic supporting functionality (e.g., read and write operations) which may be invoked through the execution of an atomic memory instruction as described herein. This term may also include any interface and control logic necessary to execute atomic memory instructions (e.g., a Northbridge chip, DDR controller, etc.). A memory may also comprise a collection of devices, each of which is a memory (e.g., collections of memory chips, RAM sticks, caches, hard drives, etc.)

An “atomic memory instruction,” as used herein, is data which may be executed (i.e., read, decoded, and acted upon) by or on a memory. To execute an atomic memory instruction, the memory may invoke some of its built-in functionality. Such functionality typically minimally comprises, but is not limited to: read operations, wherein data stored within the memory is made available externally; and write operations, wherein external data is written to the memory. Atomic memory instructions are typically received by a memory after being transmitted through one or more channels from the logic issuing the atomic memory instruction.

A “macro memory instruction,” as used here, is data representing a corresponding sequence of two or more atomic memory instructions. The macro memory instruction may comprise a unique identifier and sometimes may further comprise information representing data parameters usable in generating the corresponding sequence of atomic memory instructions.

A “memory operation,” as used here, is a particular function performed upon the data in a memory that is realized by the execution of one or more atomic memory instructions. Simple memory operations include reading and writing data in memory. More complex functions, such as copying a block of data from one area in the memory to another or comparing the contents of two blocks (i.e., contiguous address ranges) in memory, are also examples of memory operations.

A “return value,” as used herein, is data resulting from the execution of a macro memory instruction that may be sent to the processor which sent the macro memory instruction.

An “interrupt request,” as used herein, is a signal that is sent to some processors to inform them that a particular event, or kind of event, has occurred. The interrupt request may be sent to a processor indirectly through one or more interrupt controllers. On receipt of an interrupt request, a processor will typically stop working on the task it is working on, switch to a special routine for servicing the interrupt request, called an interrupt service routine (ISR), reset an interrupt status, and then continue executing instructions either from the task that was interrupted or from another task.

“Polling,” as used here, refers to a process whereby a processor sends periodic requests to a device, such as an intelligent memory controller, to determine the current status of the device (e.g., for an intelligent memory controller, the status of its execution of a macro memory instruction).

A “block memory operation,” as used here, is a memory operation concerned with the contents of a contiguous block (i.e., address range) of locations in memory.

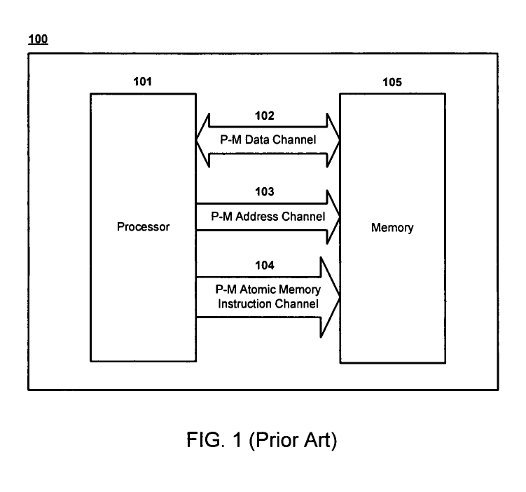

FIG. 1 shows a block diagram of an example of a basic system 100 that supports only atomic memory instructions, as known in prior art. A processor 101 is connected to a memory 105 by three channels: a P-M data channel 102, a P-M address channel 103, and a P-M atomic memory instruction channel 104. The “P-M” prefix denotes that the channels connect the processor and the memory. The P-M atomic memory instruction channel 104 is used by the processor 101 to send an atomic memory instruction to the memory 105, the P-M address channel 103 is used by the processor 101 to send the address of a memory location to the memory 105, and the P-M data channel 102 is used by the processor 101 and the memory 105 to send data in either direction between them.

For each atomic memory instruction sent by the processor 101 to the memory 105 across the P-M atomic memory instruction channel 104, the processor 101 also reasonably concurrently sends the address of a corresponding memory location to the memory 105 across the P-M address channel 103. When sending an atomic memory instruction for which data at a particular address in the memory 105 will be written, the processor 101 reasonably concurrently sends the data to be written to the addressed memory location across the P-M data channel 102. On the other hand, when sending an atomic memory instruction for which data at a particular address in memory 105 will be read, the processor 101 receives the requested data across the P-M data channel 102 after sending the atomic memory instruction and the address.

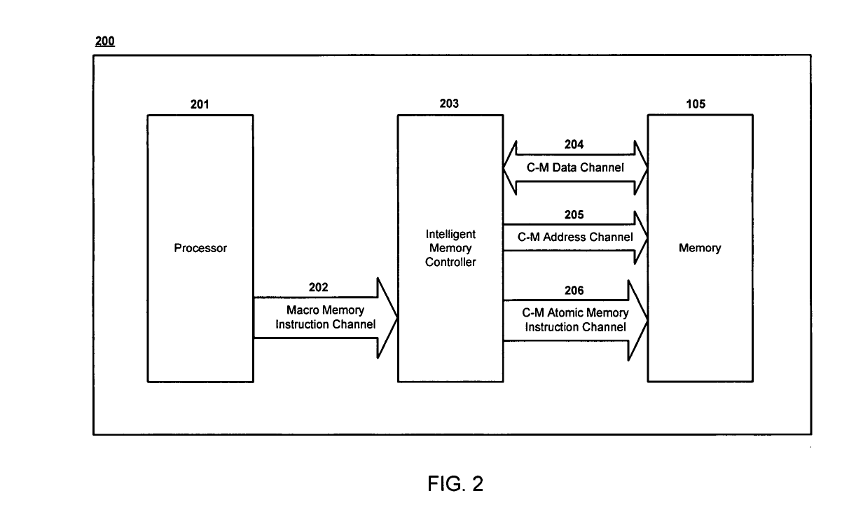

FIG. 2 shows an example of a basic system 200, in accordance with some aspects of the present invention, for supporting only macro memory instructions that do not yield return values. A processor 201 is connected (except where otherwise apparent, “connected” means operatively connected, directly or indirectly via one or more intermediates) to an intelligent memory controller 203 by a macro memory instruction channel 202. The macro memory instruction channel 202 is used by the processor 201 to send macro memory instructions to the intelligent memory controller 203.

The intelligent memory controller 203, in turn, is connected to a memory 105 by three channels: a C-M data channel 204, a C-M address channel 205, and a C-M atomic memory instruction channel 206. The “C-M” prefix denotes that the channels connect the intelligent memory controller and the memory. The C-M atomic memory instruction channel 206 is used by the intelligent memory controller 203 to send an atomic memory instruction to the memory 105, the C-M address channel 205 is used by the intelligent memory controller 203 to send the address of a memory location to the memory 105, and the C-M data channel 204 is used by the intelligent memory controller 203 and the memory 105 to send data in either direction between them. In this and other example embodiments, it is understood that the processor 201, intelligent memory controller 203, and memory 105 need not all be constructed upon or within the same substrate.

After receiving a macro memory instruction sent by the processor 201, the intelligent memory controller 203 generates and sends a corresponding sequence of atomic memory instructions to the memory 105 across the C-M atomic memory instruction channel 206. This generation of atomic instructions may be accomplished in a variety of ways. For example, a general purpose processor may be used to execute a series of instructions. This series of instructions may represent a subroutine corresponding to a given macro memory instruction. The atomic instructions implementing each macro memory instruction in the system's design repertoire may be stored in an instruction memory and selectively accessed and executed. Alternatively, special-purpose logic may be generated for producing behavior equivalent to that of the programmed general-purpose processor example given above, with atomic instruction sequences either hard-coded or stored in an arrangement and configuration of specialized logic constructed for each macro memory instruction. Logic (e.g., a multiplexer) may be used for invoking the appropriate special-purpose logic based upon the incoming macro memory instruction.

For some macro memory instructions, it is possible to generate the entire corresponding sequence of atomic memory instructions before sending any of the generated atomic memory instructions to the memory 105. For other macro memory instructions (e.g., when the generation of an atomic memory instruction depends upon the contents of a memory location affected by an atomic memory instruction generated earlier in the corresponding sequence), the corresponding sequence of atomic memory instructions must necessarily be generated interactively (i.e., interleaved with the execution of the atomic memory instructions by the memory 105). Therefore, it may be impossible to predict the number of atomic memory instructions (and time) required to execute certain macro memory instructions without knowing the contents of at least some of the memory locations and simulating the execution of the command.

For each atomic memory instruction sent to the memory 105 by the intelligent memory controller 203, the intelligent memory controller 203 calculates a corresponding memory address and reasonably concurrently sends the address to the memory 105 across the C-M address channel 205. The calculation of the memory address may involve performing arithmetic or logical functions using at least one of: data contained within the macro memory instruction and data read from the memory 105 or sent by the processor 201. When sending an atomic memory instruction for which data at a particular address in the memory 105 will be written, the intelligent memory controller 203 reasonably concurrently sends the data to be written to the addressed memory location across the C-M data channel 204. On the other hand, when sending an atomic memory instruction for which data at a particular address in memory 105 will be read, the intelligent memory controller 203 receives the requested data across the C-M data channel 204 after sending the atomic memory instruction and the address. It is noted that this scheme for communicating between a processor, intelligent memory controller, and memory is one of a great many conceivable schemes for doing so and is not intended to limit the scope of the invention to systems implementing the interface described above. For example, the data, address, and instructions may be interleaved on a single channel and sent using a variety of temporal relationships.

The system shown in FIG. 2 provides the desired ability to delegate memory instructions to the intelligent memory controller 203 that would ordinarily be executed by the processor 201. The transmission of a single macro memory instruction across the macro memory instruction channel 202 can be performed in a fixed amount of time irrespective of the number of memory locations in the memory 105 which are affected by the macro memory instruction. On the other hand, the number of corresponding atomic memory instructions issued by the intelligent memory controller 203 is substantially proportional to the number of memory locations in the memory 105 which are affected by the memory operation.

In general, the time required for the processor 201 to send a macro memory instruction is substantially less than the time necessary for the intelligent memory controller 203 to generate and send to the memory 105 the corresponding sequence of atomic memory instructions. The processor 201 may use the time saved to perform other useful tasks that do not depend upon the return result or consequences of executing the macro memory instruction on the memory 105.

While this example embodiment supports macro memory instructions, it is somewhat limited in its ability to do so. The embodiment provides no channel for the intelligent memory controller 203 to send information to the processor 201. It is recognized that the set of macro memory instructions that can therefore be supported by this basic example embodiment is restricted to those for which the processor 201 does not require a return value or notice of completion from the intelligent memory controller 203. Additionally, this embodiment does not provide a channel for the processor 201 to send an atomic memory instruction and its corresponding address and data (if applicable) to the intelligent memory controller 203. A separate interface between the processor 201 and the memory 105 would therefore be necessary for the system to support atomic memory instructions in addition to macro memory instructions. Such an arrangement, without logic for coordinating access to the memory 105, could cause contention between the atomic memory instructions issued on the one hand, by the processor 201 and, on the other, by the intelligent memory controller 203. Such contention, if not prevented, could lead to inconsistent and incorrect results when effecting memory operations on the memory 105. Accordingly, contention (i.e., collision) avoidance logic (not shown) should be included.

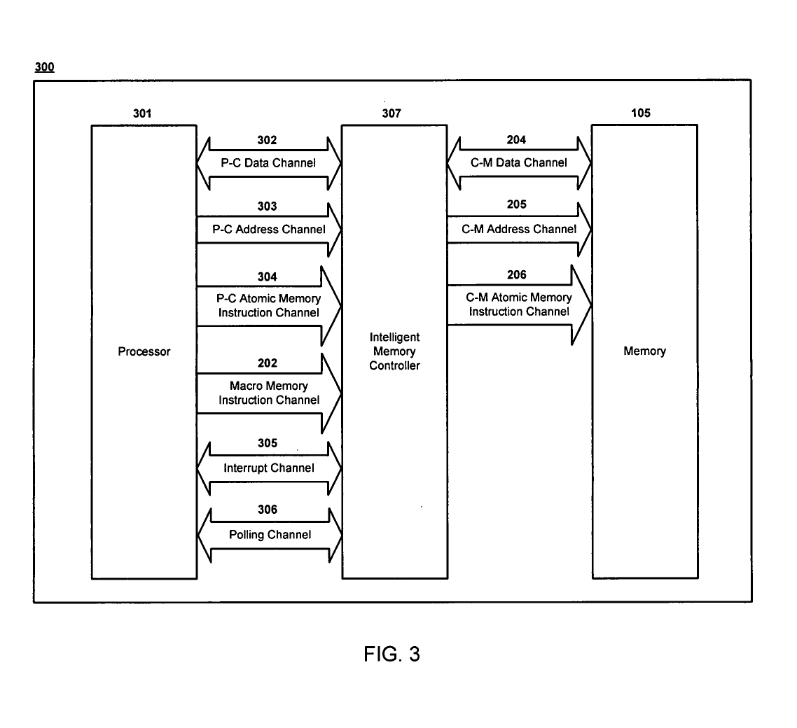

FIG. 3 shows an example of a more complex system 300, in accordance with some aspects of the present invention, for supporting both macro memory instructions and atomic memory instructions which may yield return values. The channels 202, 204, 205, and 206 remain functionally unchanged from their earlier descriptions. Five additional channels connect the processor 301 to the intelligent memory controller 307: a P-C data channel 302, a P-C address channel 303, a P-C atomic memory instruction channel 304, an interrupt channel 305, and a polling channel 306. The prefix “P-C” denotes that the channels connect the processor and the intelligent memory controller.

The P-C data channel 302 is used by the processor 301 and the intelligent memory controller 307 to send data in both directions between them. The P-C address channel 303 is used by the processor 301 to send the address of a memory location in the memory 105 (either virtual or physical) to the intelligent memory controller 307. The P-C atomic memory instruction channel 304 is used by the processor 301 to send atomic memory instructions to the intelligent memory controller 307. The interrupt channel 305 is used by the intelligent memory controller 307 to send interrupt requests to the processor 301 and by the processor 301 to send interrupt acknowledgements to the intelligent memory controller 307. The polling channel 306 is used by the processor 301 to send status requests to the intelligent memory controller 307 and by the intelligent memory controller 307 to send status updates to the processor 301.

In addition to supporting macro memory instructions sent from the processor 301, the intelligent memory controller 307 in this example embodiment also supports atomic memory instructions sent from the processor 301. For each atomic memory instruction sent by the processor 301 to the intelligent memory controller 307 across the P-C atomic memory instruction channel 304, the processor 301 also reasonably concurrently sends the address of a memory location to the intelligent memory controller 307 across the P-C address channel 303. When sending an atomic memory instruction for which data at a particular address in the memory 105 will be written, the processor 301 additionally reasonably concurrently sends the data to be written to the addressed memory location across the P-C data channel 302. On the other hand, when sending an atomic memory instruction for which data at a particular address in memory 105 will be read, the processor 301 receives the requested data across the P-C data channel 302 (via the C-M data channel 204 and the intelligent memory controller 307) after sending the atomic memory instruction and the address.

After receiving the atomic memory instruction, address, and any data (if applicable) from the processor 301, the intelligent memory controller 307 may, for example, simply resend the atomic memory instruction, address, and data (if applicable) to the memory 105. In this case, there is no need to calculate an address or generate an atomic memory instruction since these have been provided by the processor 301. For atomic memory instructions which read data from the memory 105, the data sent by the memory 105 to the intelligent memory controller 307 across the C-M data channel 204, is sent to the processor 301 across the P-C data channel 302. A benefit of this embodiment is that the intelligent memory controller 307 may provide a single, exclusive interface to the memory 105 and prevent single atomic memory instructions from being executed until all atomic memory instructions in the sequence of atomic memory instructions corresponding to a macro memory instruction have been executed. Consequently, this architecture ensures atomic and macro memory instructions sent by the processor 301 are executed such as to prevent the memory from entering an inconsistent state.

After completing the execution of an atomic or macro memory instruction, especially those for which data is returned to the processor 301, the intelligent memory controller 307 may send an interrupt request across the interrupt channel 305 to the processor 301, as shown, or indirectly to the processor via one or more interrupt request controllers (not shown). The interrupt request alerts the processor 301 that an atomic or macro memory instruction has been executed by the intelligent memory controller 307 and that an applicable return value or read data is available on the P-C data channel 302. Once the processor 301 has received and handled the interrupt request, an interrupt acknowledgement may be sent from the processor 301 to the intelligent memory controller 307 across the interrupt channel 305, informing the intelligent memory controller 307 that the interrupt request has been received and handled. The interrupt request mechanism permits the processor 301 to switch efficiently to other tasks while the delegated instructions are executed by the intelligent memory controller 307.

The processor 301 may also (or alternatively in another embodiment) periodically poll the intelligent memory controller 307 to request the status of the execution of an atomic or macro memory instruction delegated by the processor 301 to the intelligent memory controller 307. In response to a status request sent by the processor 301, the intelligent memory controller 307 may send a status update across the polling channel 306, informing the processor 301 of the current status of the execution of an atomic or macro memory instruction. Upon being informed that an atomic or macro memory instruction has completed execution, the processor 301 may receive the return value or read data (if applicable) sent by the intelligent memory controller 307 to the processor 301 across the P-C data channel 302.

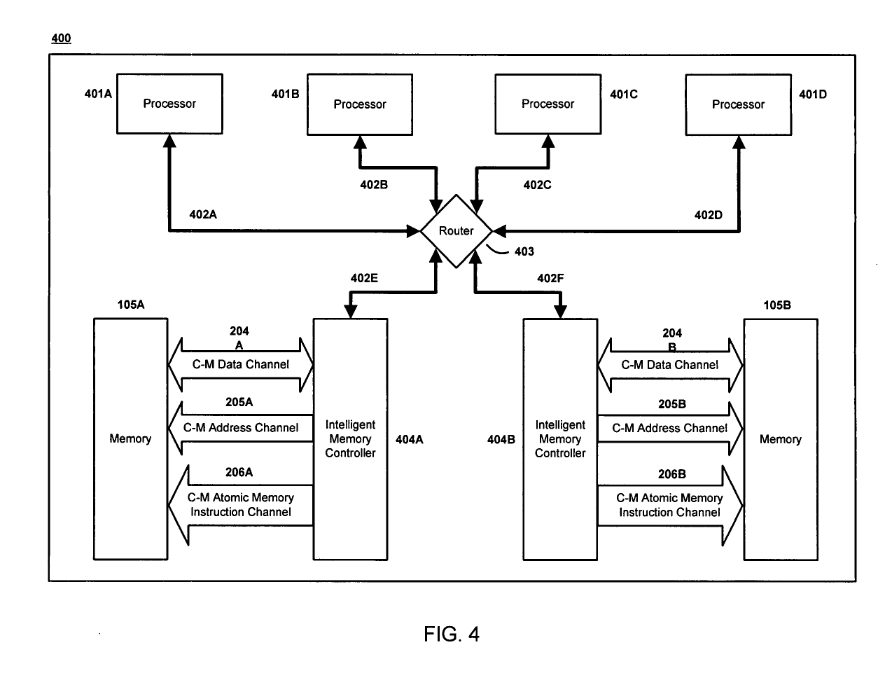

FIG. 4 shows an example of a more general system 400 supporting macro memory instructions with multiple processors, intelligent memory controllers, and memories according to aspects of the present invention. The processors 401A, 401B, 401C, and 401D are connected to the intelligent memory controllers 404A and 404B by a communication network comprising a plurality of links 402A, 402B, 402C, 402D, 402E, and 402F and a router 403. Each intelligent memory controller 404A and 404B is operatively connected to a corresponding memory 105A and 105B. The links 402A-F may be constructed in any manner suitable for sending data between the processors 401A-D and the intelligent memory controllers 404A-B. Though a single router 403 is shown, it is understood that alternative example embodiments of the system may be constructed using a variety of variant topologies and any number of processors, links, routers, intelligent memory controllers, and memories.

It is further understood that, in some aspects of the invention, one or more additional components (not shown) may be present within the system 400. Some of these additional components can be arranged and configured to communicate with the processors 401A-D and intelligent memory controllers 404A-B through the communication network. Such components may, for example, serve as intermediaries between the processors and the intelligent memory controllers for a variety of purposes, such as scheduling the execution of the macro memory instructions. These additional components may also receive the return values of the execution of macro memory instructions in the same ways disclosed herein for processors.

The communication network may be viewed as providing a medium within which all channels, including the previously disclosed channels, connecting a processor (e.g., 401A) and an associated intelligent memory controller (e.g., 404A), may be constructed. Physically, the communication network may comprise any combination of links, media, and protocols capable of supporting the necessary channels. The router 403 maybe be configured to allow selective communication between the processors 401A-D and the intelligent memory controllers 404A-B, or simply configured to re-send (i.e., broadcast or repeat) any data received on one link (e.g. 402A) to all the other links (e.g., 402B-F). In fact, any practical strategy of routing in networks may be employed by the router 403. It to be understood that well-known techniques such as media access control (MAC) and network addressing for communicating in data networks may be applicable. Finally, it is noted that the processors 401A-D need not be identical in construction and capabilities, nor must the memories 105A-B. It is recognized that the components of the system 400 may, but need not, be constructed upon the same substrate(s).

When considering an embodiment of the type shown in FIG. 4, further benefits of supporting macro memory instructions become apparent. Because multiple processors 401A-D share a communication network, the utilization of the bandwidth on the communication links 402E-F may be of concern. By supporting macro memory instructions, only a single macro memory instruction is sent over the communication network from a processor (e.g., 401A) to an intelligent memory controller (e.g., 404A), as opposed to a traditional system, wherein a series of atomic memory instructions proportional in length to the number of memory locations affected would be sent across a communication link (e.g., 402E). Therefore, supporting macro memory instructions may lead to a significant decrease in the utilization of at least portions of the communication network.

Each intelligent memory controller (e.g., 404A) provides an exclusive interface to each memory (e.g., 105A) and, therefore, the intelligent memory controller (e.g., 404A) can be used to manage access to the memory (e.g., 105A). Such management may include, for example, providing quality of service (i.e., supporting multiple priority levels for access to a memory by the processors), memory partitioning (i.e., assigning memory locations of a memory for exclusive use by a particular processor), and interleaving the execution of macro memory instructions sent from multiple processors to reduce average wait times.

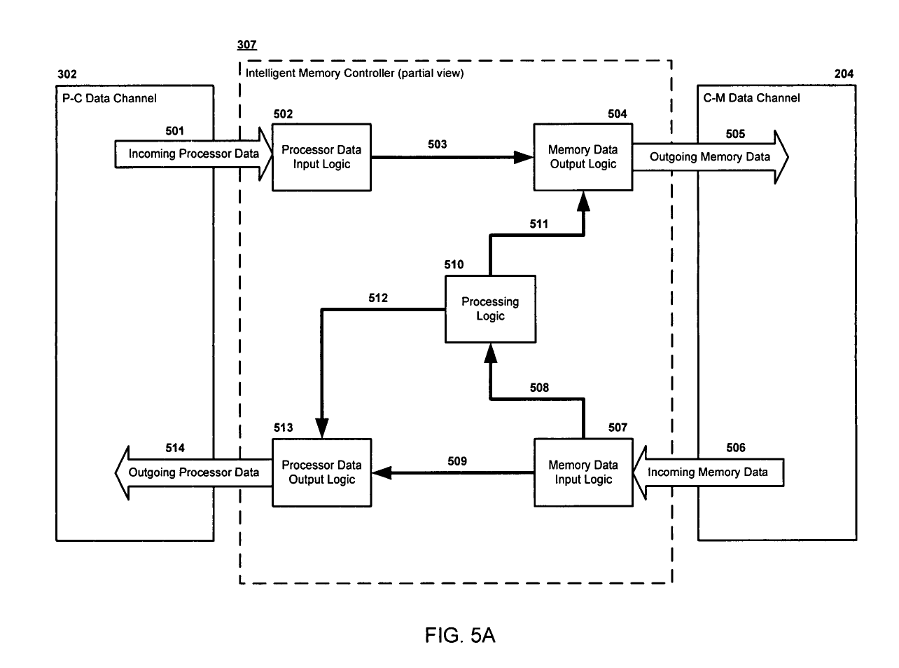

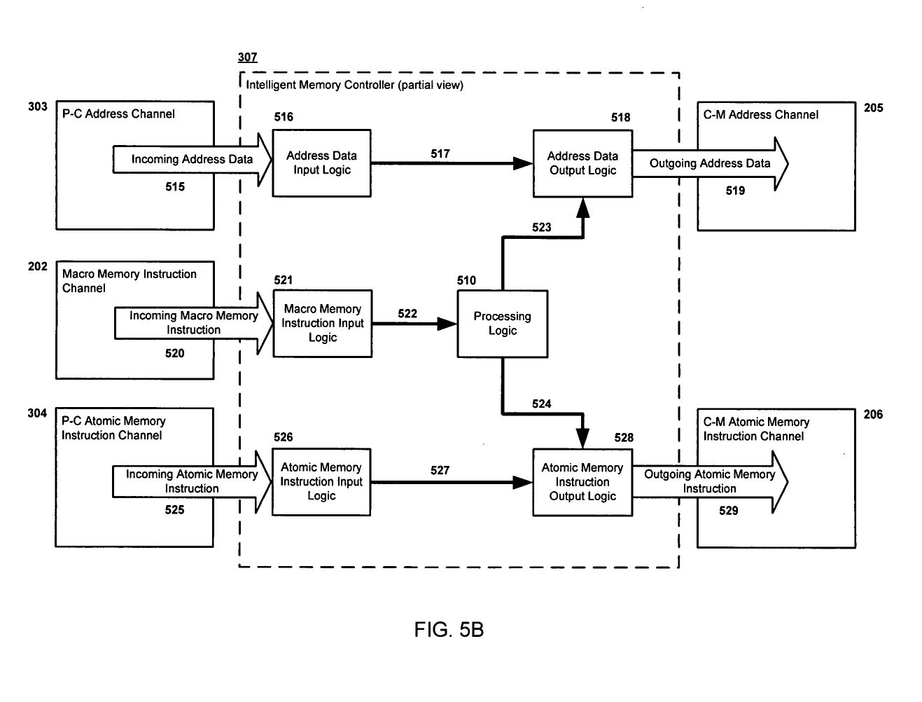

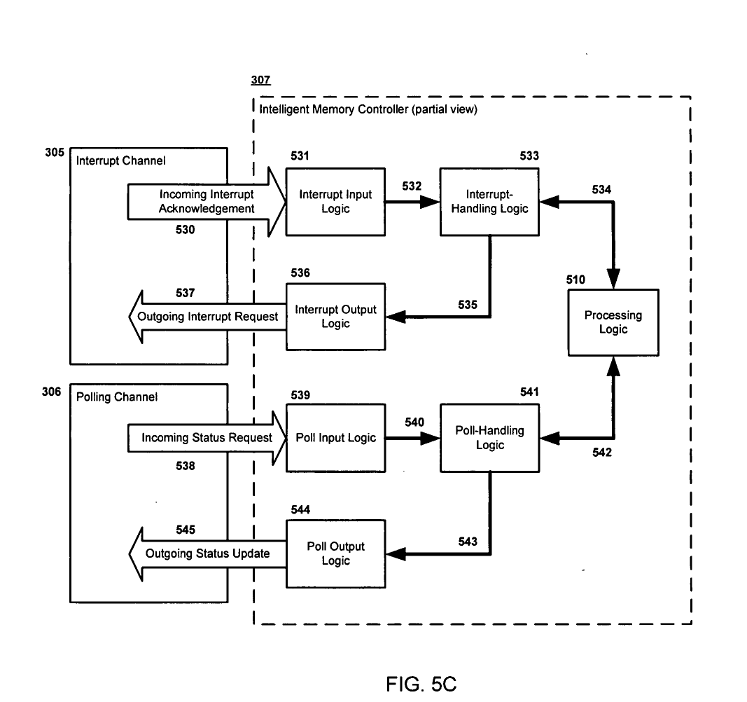

FIGS. 5A, 5B, and 5C are partial block/functional diagrams of logical modules implementing an example embodiment of an intelligent memory controller such as the one illustrated in FIG. 3. Naturally, additional control logic (not shown) may be necessary to coordinate timing and the flow of data as well as to direct data along the appropriate communication link(s) when several choices are available. This logic has intentionally be left out of the figures for clarity as it is implicit in the descriptions that follow and implementation is within the skill of the artisan. It is additionally understood that the various logic modules depicted may be physically realized in a less modular way and may share common, overlapping logic. It is even possible that separate schematic modules be physically implemented by the same logic. The communication links depicted as linking the logical modules may also exist only as coupled logic rather than as a formal, well-structured communication link, or may not exist at all in a given physical implementation. Finally, these figures are intended to demonstrate one of many possible embodiments of an intelligent memory controller supporting macro memory instructions and are not intended to limit the scope of the invention to the particular arrangement of logic depicted.

FIG. 5A is first described. In this example embodiment of the internal logic for the intelligent memory controller 307, the incoming processor data 501 that is sent across the P-C data channel 302 is received by processor data input logic 502. The incoming processor data 501 is then sent along a communication link 503 to the memory data output logic 504 to be resent as outgoing memory data 505 across the C-M data channel 204. This mode of operation is applicable when the intelligent memory controller 307 has been sent an atomic memory instruction from the processor 301 to be passed on to the memory 105.

After sending an atomic memory instruction for which data is returned, the intelligent memory controller 307 receives the requested incoming memory data 506 across the C-M data channel 204. This incoming memory data 506 is received by the memory data input logic 507. For incoming memory data 506 that results from the receipt of an atomic memory instruction sent from the processor 301, the memory data input logic 507 sends the incoming memory data 506 along a communication link 509 to the processor data output logic 513 to be sent as outgoing processor data 514 across the P-C data channel 302.

For incoming memory data 506 that results from the execution of an atomic memory instruction generated from a macro memory instruction, the incoming memory data 506 may be sent to the processing logic 510 along a communication link 508, where the processing logic 510 may calculate a return value or update its current state for the purpose of generating additional atomic memory instructions and a future return value. When a return value is calculated by the processing logic 510, it is sent via a communication link 512 to the processor data output logic 210 and then sent as outgoing processor data 514 across the P-C data channel 302 to the processor 301. As discussed previously, this return occurs when the processor 301 handles an interrupt or as the result of the processor 301 polling the intelligent memory controller 307.

Additionally, when generating an atomic memory instruction as part of the corresponding sequence of atomic memory instructions resulting from the execution of a macro memory instruction, the processing logic 510 may generate an atomic memory instruction that writes data to a location in the memory 105. This data is sent from the processing logic 510 along a communication link 511 to the memory data output logic 504, to be sent as outgoing memory data 505 across the C-M data channel 204. As specified earlier, this is done reasonably concurrently with the sending of the corresponding address data and atomic memory instruction to the memory 105.

FIG. 5B is now described. For atomic memory instructions sent across the P-C address channel 303, the incoming address data 515 is received by the address data input logic 516, sent along a communication link 517 to the address data output logic 518, and then resent as outgoing address data 519 across the C-M address channel 205.

A macro memory instruction sent across the macro memory instruction channel 202 as an incoming macro memory instruction 520 is received by macro memory instruction input logic 521 and then sent along a communication link 522 to the processing logic 510. The processing logic 510 then generates one or more of the atomic memory instructions for the corresponding sequence of atomic memory instructions, along with the memory address and data (if applicable, as described earlier) for each.

The generated address for the atomic memory instruction is sent along a communication link 523 to the address data output logic 518 to be sent as outgoing address data 519 across the C-M address channel 205. The address data output logic 518 sends the outgoing address data 519 reasonably concurrently to the sending of the outgoing atomic memory instruction 529 and outgoing memory data 505 (if applicable).

The generated atomic memory instruction is sent from the processing logic 510 along a communication link 524 to atomic memory instruction output logic 528 to be sent as an outgoing atomic memory instruction 529 across the C-M atomic memory instruction channel 206. As stated earlier, this is also done reasonably concurrently with sending the outgoing address data 519 and the outgoing memory data 505 (if applicable). For the case where the processor 301 sends an atomic memory instruction to the intelligent memory controller 307 along the P-C atomic memory instruction channel 304, the incoming atomic memory instruction 525 is received by the atomic memory instruction input logic 526. The atomic memory instruction is then sent along a communication link 527 to the atomic memory instruction output logic 528, where it is resent as an outgoing atomic memory instruction 529 across the C-M atomic memory instruction channel 206.

As shown in FIG. 5C, upon completing the execution of an atomic or macro memory instruction, the processing logic 510 may inform the interrupt-handling logic 533 by sending data across a communication link 534. The processing logic 510 also sends to the processor data output logic 513 (see FIG. 5A) any applicable return value to be sent to the processor as previously disclosed. The interrupt-handling logic 533 then sends an interrupt request along a communication link 535 to the interrupt output logic 536, which sends it as an outgoing interrupt request 537 across the interrupt channel 305.

Upon handling the interrupt request, the processor 301 may then send an interrupt acknowledgement across the interrupt channel 305 as an incoming interrupt acknowledgement 530 to the interrupt input logic 531, which sends it across a communication link 532 to the interrupt-handling logic 533. The interrupt-handling logic 533 may then inform the processing logic 510 that the interrupt request has been handled, allowing the processing logic 510 to send return values for the execution of other atomic or macro memory instructions.

It may be beneficial to assign a unique identifier for each atomic or macro memory instruction. This identifier can be sent back along with the return value, to bind the return result to the delegated instruction and for use in tracking status. Such an approach is especially useful if the processor 301 sends one or more atomic or macro memory instruction to the intelligent memory controller 307 before previously sent instructions have completed their execution. Assigning each atomic or macro memory instruction a unique identifier may also permit the intelligent memory controller 307 to bundle multiple return values together, in case the processor 307 takes a while to retrieve the return values.

A processor 301 may also poll the intelligent memory controller 307 in order to determine the status of the execution of a delegated atomic or macro memory instruction (which, as stated above, may be uniquely identified). To accomplish this, the processor 301 sends a status request across the polling channel 306 as an incoming status request 538, which is received by the poll input logic 539. The poll input logic 539 then sends the incoming status request 538 along a communication link 540 to poll-handling logic 541. The poll-handling logic 541 then sends a status update request along a communication link 542 to the processing logic 510.

The processing logic 510 next sends a status update regarding the execution of particular atomic or macro memory instructions along a communication link 542 back to the poll-handling logic 541. The poll-handling logic 541 then sends the current status along a communication link 543 to the poll output logic 544, which sends it as an outgoing status update 545 across the polling channel 306. After discovering, via polling, that an issued atomic or macro memory instruction has completed execution, the processor may retrieve the return value in the usual way along the P-C data channel 302.

It is further recognized that configuring and arranging the input and output logic modules 502, 504, 507, 513, 516, 518, 521, 526, 528, 531, 536, 539, and 544 to support queuing, the intelligent memory controller 307 may more easily handle short-term differences in processing rates between the processor 301, the intelligent memory controller 307, and the memory 105. In addition, pipelining various portions of the intelligent memory controller 307 may improve throughput and provide more stable support for handling several delegated atomic or macro memory instructions sent within a relatively short time span.

The above-described systems and methods permit a processor to delegate memory operations to an intelligent memory controller supporting macro memory instructions. The processor may then utilize the resulting time savings to work on other tasks. In some embodiments, the support of macro memory instructions substantially reduces the bandwidth utilization of a common communication network connecting one or more processors and intelligent memory controllers.

To further exemplify the utility of macro memory instructions, an example will now be given in which macro memory instructions are used. For this example, four macro memory instructions are supported: FILL, COPY, DIFF and SCAN. It is noted that the present invention is not limited to these four macro memory instructions, of course, or to any specific set of macro memory instructions. The FILL instruction is usable to set a block of locations in memory to a specified value. The COPY instruction is usable to copy the contents of a specified block of memory locations to another location in memory. The DIFF instruction is usable to compare, location by location, two specified blocks of memory locations to determine the number of compared locations matching for both blocks. The SCAN instruction is usable for determining, starting from a given address, the number of memory locations which fail to match a specified value. The following table summarizes the arguments and return values for each of the macro memory instructions used in this example:

| Return Value | Instruction | Arg. 1 | Arg. 2 | Arg. 3 | Arg. 4 |
|---|---|---|---|---|---|
| None | FILL | Width | Length | Address | Value |
| None | COPY | Width | Length | Address 1 | Address 2 |
| Length of | DIFF | Width | Length | Address 1 | Address 2 |
| matching data | | | | | |
| Length of | SCAN | Width | Length | Address | Value |
| non-matching | | | | | |
| data | | | | | |

Each macro memory instruction accepts four arguments, the first two arguments being the same for each of the instructions. The first argument (i.e., Arg. 1) specifies the width (in number of bits) of a location of storage for the memory. The second argument (i.e., Arg. 2) specifies the maximum length (measured in locations of storage) that the instruction should operate over.

It is noted that a fifth argument could be provided, specifying a pattern for selecting locations within the block. While the most basic pattern is that of consecutive access (i.e., moving consecutively from one location to the next location in the block), more complicated patterns are conceivable and may include skipping over a given number of locations, visiting locations according to a provided pattern or function, etc. For the purpose of this example, it is assumed that consecutive access is being used but the present invention is intended to encompass all means of accessing memory locations within a block of memory.

For the FILL instruction, the third argument (i.e., Arg. 3) specifies the address of the first storage location in the memory that the instruction should operate on and the fourth argument (i.e., Arg. 4) specifies a value between 0 and 2^{width}−1 to which each affected location should be set. The FILL instruction does not return a value.

For the COPY instruction, the third argument (i.e., Arg. 3) specifies the address of the first location in memory to be copied. The fourth argument (i.e., Arg. 4) specifies the first location in memory to which the locations starting from the address given in the third argument should be copied. The COPY instruction does not return a value.

For the DIFF instruction, the third argument (i.e., Arg. 3) specifies an address of a first location in memory for a first block of memory locations to be compared and the fourth argument (i.e., Arg. 4) specifies an address of a first location for a second block to be compared. This process continues until the value for one of the locations in the first block of memory locations differs from the value for a corresponding location in the second block, or until a number of comparisons equaling the Length argument have been performed. The DIFF instruction returns the number of memory locations which match for the two specified blocks of memory.

Finally, for the SCAN instruction, the third argument (i.e., Arg. 3) specifies an address of a first location in a block of memory locations to be compared to a value given by the fourth argument (i.e., Arg. 4). The fourth argument specifies a value between 0 and 2^{Width}−1 to which each affected location should be compared. This process continues until every specified location has been checked or until a location is found which has a value equal to that of the value given by the fourth argument. The SCAN instruction returns the number of compared locations not matching the value specified by the fourth argument.

It should be apparent to one of ordinary skill in the art that that each macro memory instruction described above corresponds to a sequence of atomic read/write instructions as well as some basic arithmetic and logic operations which must be performed. By delegating such work to an intelligent memory controller, a processor may continue doing useful work which does not rely upon the affected memory locations or return value of the instruction.

While a programmer may explicitly specify the use of macro memory instructions such as those given above by, it may be desirable to hide such details from a programmer who is using a high-level language such as C or C++. Such an abstraction is particularly useful for a programmer wishing to gain the benefit of using a system having an intelligent memory controller without modifying the source code of an application. By using an alternative implementation of language libraries, a programmer may gain the benefit of an intelligent memory controller by specifying appropriate compilation options and then recompiling the source code. The recompilation has the effect of replacing the processor and bus-intensive versions of the primitive memory functions using only atomic memory instructions with a corresponding sequence of macro memory instructions, thereby improving system performance.

The alternative implementations of the language libraries effectively describe a mapping of primitive memory functions to a corresponding sequence of one or more macro memory instructions. The compiler thus, rather than generating a corresponding sequence of atomic memory instructions, generates a corresponding sequence of one or more corresponding macro memory instructions instead. As previously disclosed, the macro memory instructions are delegated to an intelligent memory controller, which generates the corresponding sequence of atomic memory instructions. The following table demonstrates an example of such mappings for common C/C++ primitive functions for a memory having a location width of Width and a total of MaxLen=2^{Width}−1 locations:

| Primitive Function | Equivalent Macro Memory Instruction Sequence |
|---|---|
| memcpy(d, s, n) | COPY(Width, n, s, d) |
| memmove(d, s, n) | COPY(Width, n, s, d) |
| strcpy(d, s) | t = SCAN(Width, MaxLen, s, 0) |
| | COPY(Width, t+1, d, s) |
| strncpy(d, s, n) | t = SCAN(Width, MaxLen, s, 0) |
| | COPY(Width, minimum(n, t+1), d, s) |
| memset(p, v, c) | FILL(Width, c, p, v) |
| strlen(p) | SCAN(Width, MaxLen, p, 0) |
| strchr(p, c) | t = SCAN(Width, MaxLen, p, 0) |
| | SCAN(Width, t, p, c) |
| strcmp(p1, p2) | t1 = SCAN(Width, MaxLen, p1, 0) |
| | t2 = SCAN(Width, MaxLen, p2, 0) |
| | DIFF(Width, minimum(t1, t2), p1, p2) |

In this example, for each of the above primitive functions (in the left column), the processor performs the task of delegating a relatively small number of corresponding macro memory instructions (in the right column) to an intelligent memory controller. This delegation allows the processor to execute a fixed number of instructions per primitive function rather than performing a sequence of atomic memory instructions having a number which is typically substantially proportional to the number of relevant locations in memory being affected. It is recognized that other methods for replacing atomic memory instructions in source or object code exist other than providing alternative implementations of the language libraries. For example, a source or object code analyzer may be used to analyze the memory access patterns of the code and either automatically or semi-automatically replace the original code with code optimized for use with a given set of macro memory instructions.

Having described some illustrative embodiments of the invention, it should be apparent to those skilled in the art that the foregoing is merely illustrative and not limiting, having been presented by way of example only. Numerous modifications and other embodiments will occur to one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Acts, elements, and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known or later developed, for performing the recited function. The invention, thus, is limited only as required by the appended claims and equivalents thereof.

What is claimed is:

1. An intelligent memory controller supporting macro memory instructions comprising:
processing logic configured and arranged to receive macro memory instructions from input logic and generate, for each received macro memory instruction, a corresponding sequence of atomic memory instructions; and
output logic configured and arranged to send outgoing data to a memory, the outgoing data comprising the atomic memory instructions from the processing logic.

2. The controller of claim 1, further comprising output logic configured and arranged to send outgoing data to the processor.

3. The controller of claim 2, wherein the outgoing data sent to the processor comprises a return value resulting from the execution of a macro memory instruction.

4. The controller of claim 2, further comprising logic configured and arranged to receive a status request and send a status update, the status update comprising the status of the execution of a macro memory instruction.

5. The controller of claim 1, further comprising input logic configured and arranged to receive incoming data from the memory.

6. The controller of claims 1, 2, or 5, further comprising logic configured and arranged to support the queuing of at least some of the incoming and outgoing data.

7. The controller of claims 1 or 5, further comprising logic configured and arranged to perform arithmetic operations using at least some of the incoming data.

8. The controller of claims 1 or 5, further comprising logic configured and arranged to perform logical operations using at least some of the incoming data.

9. The controller of claim 1, further comprising logic configured and arranged to send an interrupt request after a macro memory instruction is executed.

10. An information processing system supporting macro memory instructions comprising:
a processor;
memory; and
an intelligent memory controller, the intelligent memory controller being configured and arranged to receive a macro memory instruction issued by the processor and to execute the macro memory instruction by effecting on the memory a corresponding sequence of atomic memory instructions.

11. The system of claim 10, wherein the macro memory instruction is selected from among a set of macro memory instructions, the set of macro memory instructions consisting substantially of block memory operations.

12. The system of claim 10, wherein the processor and intelligent memory controller are constructed upon a same substrate.

13. The system of claim 10, wherein the intelligent memory controller is constructed upon a first substrate and the processor is constructed upon a second substrate different from the first substrate.

14. The system of claim 12 or 13, wherein the memory and the intelligent memory controller are constructed upon a same substrate.

15. The system of claim 12, wherein the memory is constructed upon a second substrate different from the substrate upon which the processor and intelligent memory controller are constructed.

16. The system of claim 13, wherein the memory is constructed upon a third substrate different from the first substrate and second substrate.

17. The system of claim 10, wherein the intelligent memory controller is configured and arranged to notify the processor of the completion of the execution of a macro memory instruction.

18. The system of claim 10, wherein the memory is configured and arranged to notify the processor of the completion of the execution of a macro memory instruction.

19. The system of claims 17 or 18, wherein the notification is at least partly accomplished by setting an interrupt.

20. The system of claim 10, wherein the intelligent memory controller is configured and arranged to send the processor a return value for the execution of a macro memory instruction.

21. The system of claim 10, wherein the memory is configured and arranged to send the processor a return value for the execution of a macro memory instruction.

22. The system of claim 20 or 21, wherein the return value is sent, at least partly, by setting the contents of a register.

23. The system of claim 10, wherein the intelligent memory controller notifies the processor of completion of the execution of the macro memory instructions in response to a status request sent by the processor.

24. The system of claim 10, wherein the intelligent memory controller comprises hard-wired logic.

25. The system of claim 10, wherein the intelligent memory controller comprises a processor.

26. The system of claim 10, wherein the processor comprises a plurality of processors.

27. The system of claim 26, further including a communication network operatively interconnecting at least two of the processors and the intelligent memory controller for communication and wherein the macro memory instructions are delivered through the communication network.

28. The system of claim 27, wherein the communication network is constructed to provide selective communication between the processors and the intelligent memory controller.

29. The system of claim 28, further including an intermediary component, and wherein the macro memory instructions are delivered from a processor to the intelligent memory controller via the intermediary component.

30. The system of claim 29, wherein macro memory instructions issued by at least two of the plurality of processors are delivered to the intelligent memory controller via the intermediary component, and wherein the intermediary component schedules the execution of each of the macro memory instructions delivered through it.

31. The system of claim 29, wherein the intermediary component is arranged and configured to receive a return value sent by the intelligent memory controller.

32. A method of operating a computer system comprising acts of:
(A) a processor issuing a macro memory instruction;
(B) an intelligent memory controller receiving the issued macro memory instruction; and
(C) the intelligent memory controller executing the issued macro memory instruction by effecting on a memory a corresponding sequence of atomic memory instructions.

33. The method of claim 32, further comprising the act of:
(D) after the completion of act (C), the intelligent memory controller notifying the processor.

34. The method of claim 32, further comprising the act of:
(E) after the completion of act (C), the memory notifying the processor.

35. The method of claim 33 or 34, wherein an interrupt request notifies the processor.

36. The method of claim 32, further comprising the act of:
(F) upon completion of act (C), the intelligent memory controller sending the processor a return value for the execution of the macro memory instruction.

37. The method of claim 32, further comprising the act of:
(G) upon completion of act (C), the memory sending the processor a return value for the execution of the macro memory instruction.

38. The method of claim 36 or 37, wherein the return value is sent, at least partly, by setting of the contents of a register.

39. The method of claim 36 or 37, wherein the return value is sent at least partly through a communication network, the communication network permitting communication between the processor and the intelligent memory controller.

40. The method of claim 39, wherein the macro memory instruction is sent to the intelligent memory controller via an intermediary component.

41. The method of claim 40, wherein the return value is sent to the intermediary component.

42. The method of claim 32, further comprising the act of:
(H) the processor polling the intelligent memory controller.

43. The method of claim 32, further comprising the act of:
(I) the processor polling the memory.

44. The method of claim 42 or 43, further comprising the act of:
(J) a return value for the execution of the macro memory instruction being sent to the processor.

45. The method of claim 32, further comprising the act of:
(K) subsequent to act (A) and prior to the completion of act (C), the processor continuing to execute instructions.

46. The method of claim 32, further comprising the act of:
(L) prior to act (B), the issued macro memory instruction being selectively routed through a communication network to the communication channel of act (B).
